(19) United States
(12) Patent Application Publication
(10) Pub. No.: US 2011/0250506 A1
(43) Pub. Date: Oct. 13, 2011

(54) NON-AQUEOUS ELECTROLYTE SECONDARY BATTERY

(75) Inventor: Hizuru Koshina, Mountain View, CA (US)

(73) Assignee: Panasonic Corporation, Osaka (JP)

(21) Appl. No.: 12/757,445

(22) Filed: Apr. 9, 2010

(51) Int. Cl. H01M 6/16; H02J 7/04

(52) U.S. Cl. 429/338; 320/162

(57) ABSTRACT

A lithium secondary battery comprises a negative electrode, a positive electrode comprising a current collector, an active cathode material comprising a lithium transition metal complex oxide, and sulfur, and an electrolyte comprising at least one lithium salt and at least one solvent. The at least one lithium salt is one of LiPF₆, LiAsF₆, LiBF₄, LiClO₄, and mixtures thereof, and the at least one solvent is one of ethylene carbonate, propylene carbonate, butylene carbonate, ethyl methyl carbonate, dimethyl carbonate, diethyl carbonate, and mixtures thereof. The electrolyte remains stable throughout a state of overcharge. A method of using the lithium secondary battery includes overcharging the battery and maintaining the heat generation of the positive electrode comprising sulfur at levels lower relative to a positive electrode without sulfur.

### FIELD OF THE INVENTION

The present invention relates to a cathode for improving the overcharge safety of a lithium battery.

### BACKGROUND OF THE INVENTION

In recent years, electronic information devices, such as personal computers, cell phones, and personal digital assistants (PDA), as well as audio-visual electronic devices, such as video camcorders and MP3 players, are rapidly becoming smaller, lighter in weight, and cordless. Secondary batteries having high energy density are increasingly in high demand as power sources for these electronic devices. Thus, non-aqueous electrolyte secondary batteries, having higher energy density than obtainable by conventional lead-acid batteries, nickel-cadmium storage batteries, or nickel-metal hydride storage batteries, have come into general use. Among non-aqueous electrolyte secondary batteries, lithium-ion secondary batteries, and lithium-ion polymer secondary batteries are under advanced development.

A lithium battery comprises a cathode, an anode, an electroyte, and a separator disposed between the cathode and anode. Lithium batteries produce electrical energy by intercalation/deintercalation of lithium ions during oxidation and reduction occurring at the anode and the cathode, respectively. If a battery is overcharged, excess lithium is precipitated at the cathode and excess lithium is intercalated into the anode. This can cause the cathode and anode to become thermally unstable, the electrolyte can decompose, and rapid heat generation or thermal runaway can occur resulting in an unsafe battery. Thus, overcharge protection agents have been investigated to suppress or prevent overcharge of the battery.

Most overcharge protection agents can be categorized as (1) a simple overcharge protection agent or (2) a redox type protection agent. Simple overcharge protection agents begin to react at a high potential of about 4.60V or 4.65V versus lithium electrode potential, i.e., they operate during overcharging by making a protective film or cover on the surface of the cathode. These battery cells, however, are destroyed after overcharging. Typical simple overcharge protection agents may include BP (biphenyl) and CHB (cyclohexyl benzene). Redox type protection agents operate during overcharging but after overcharging the battery cell can be re-used properly. Redox agents bring electrons between the anode and cathode during overcharging. Typical redox type agents may include [Fe(phen)₃](PF₆)₂, [Fe(5-Cl-phen)₃](PF₆)₂, [Fe(5-NO₂-phen)₃](PF₆)₂, [Ru(phen)₃](PF₆)₂, [Fe(bpy)₃](PF₆)₂, Ir(phen) Cl₃, Ferrocene, 4,4′-dimethoxybiphenyl, TPPi (triphenylphosphite), TPA (triphenylamine), tris 4-bromophenylamine, and tris 2-dibromophenylamine and 4-dibromophenylamine.

Overcharge protection agents may not work effectively for all 3 volt (3V) and 4 volt (4V) battery systems. Common 3V cathode systems may include Li/TiS₂ or Li/MnO₂, and common 4V battery systems may include LiCoO₂/graphite, LiFePO₄/graphite, Li(NiCoAl)O₂/graphite, LiMn₂O₄, or LiNiO₂ battery systems. For 3V battery systems, overcharge protection agents such as metallocenes work as a redox couple between the cathode and anode when the cell voltage reaches to the overcharging region. But these overcharge protection agents are not enough for current lithium ion battery systems which are operating at 4V. Furthermore, a redox type agent such as tris 2 and 4-dibromophenylamine may have an onset potential of 3.09-4.29V versus lithium electrode potential, but onset potentials of those agents are only available for lower operating cathode materials such as LiFePO₄ and cannot be used for some cathodes because onset potentials of those agents are the same potential or lower than the operating range of the cathodes. Thus, an appropriate and effective overprotection agent was investigated for 4V cathode systems.

### SUMMARY OF THE INVENTION

According to one embodiment of the present invention, a lithium secondary battery comprises a negative electrode, a positive electrode comprising a current collector, an active cathode material comprising a lithium transition metal complex oxide, and sulfur, and an electrolyte comprising at least one lithium salt and at least one solvent, the at least one lithium salt is selected from the group consisting of LiPF₆, LiAsF₆, LiBF₄, LiClO₄, and mixtures thereof, and the at least one solvent is selected from the group consisting of ethylene carbonate, propylene carbonate, butylene carbonate, ethyl methyl carbonate, dimethyl carbonate, diethyl carbonate, and mixtures thereof. The electrolyte remains stable throughout a state of overcharge.

According to another embodiment of the present invention, a lithium is secondary battery comprises a cathode comprising a mixture of sulfur and a lithium transition metal complex oxide selected from the group consisting of LiMPO₄, LiMO₂ and LiM₂O₄ (where M includes transition metal(s) or substitutes Al and/or Mg to the transition metal site), an anode comprising a graphite and/or lithium alloy comprising a transition metal and/or a P-element selected from the group consisting of Si, Sn, Al, Pb, Bi, In, Ag, Pt, and Ti, and an electrolyte comprising at least one lithium salt selected from the group consisting of LiPF₆, LiAsF₆, LiBF₄, and LiClO₄ and at least one solvent selected from the group consisting of ethylene carbonate, propylene carbonate, butylene carbonate, ethyl methyl carbonate, dimethyl carbonate, and diethyl carbonate. The electrolyte remains stable throughout a state of overcharge.

According to another embodiment of the present invention, a method of using a lithium secondary battery comprises overcharging a lithium secondary battery comprising a negative electrode, a positive electrode comprising sulfur and an active cathode material comprising a lithium transition metal complex oxide, and an electrolyte comprising at least one lithium salt and at least one solvent. The heat generation of the positive electrode comprising sulfur is maintained at levels lower relative to a positive electrode without sulfur during the overcharge.

### BRIEF DESCRIPTION OF THE DRAWING

The invention may be understood from the following detailed description of the invention when read in connection with the accompanying drawings. Included in the drawings are the following figures:

FIG. 1 is a cyclic voltamgram for a conventional reaction of a sulfur-containing electrode;

FIG. 2 is a cyclic voltamgram for a sulfur-containing electrode according to one embodiment of the present invention;

FIG. 3 is graph showing the charging and discharging curves during 3 to 4.25V according to a comparative example and different embodiments of the present invention;

FIG. 4 is a graph showing the charging curves up to 5V for a comparative example without sulfur;

FIG. 5 is a graph showing the charging curves up to 5V for one embodiment of the is present invention with 0.2% sulfur;

FIG. 6 is a graph showing the charging curves up to 5V for one embodiment of the present invention with 0.5% sulfur;

FIG. 7 is a graph showing the charging curves up to 5V for one embodiment of the present invention with 1.0% sulfur;

FIG. 8 is a graph showing the charging curves up to 5V for one embodiment of the present invention with 2.0% sulfur;

FIG. 9 is a graph showing the charging curves up to 5V for one embodiment of the present invention with 5.0% sulfur;

FIG. 10 is a graph showing the relationship between sulfur concentration and heat generation after charging at 4.25V, 4.6V, and 5.0V according to a comparative example and different embodiments of the present invention; and

FIG. 11 is a schematic drawing of an example of a non-aqueous electrolyte secondary battery.

### DETAILED DESCRIPTION OF THE INVENTION

Aspects of the present invention include a lithium secondary battery and a method of using a lithium secondary battery.

When a lithium ion battery is overcharged, excess lithium ions are released from a cathode and migrate to an anode, which could cause the cathode and the anode to become thermally unstable. When the cathode and the anode are thermally unstable, an organic solvent, particularly a carbonate-based organic solvent in an electrolyte, begins to decompose at 5 volts or higher. Decomposition of an electrolyte causes heat runaway, so that the battery may combust, swell, or rupture. Furthermore, the loss of oxygen from a charged lithium-transition-metal oxide electrodes, such as LiCoO₂ electrodes, can contribute to exothermic reactions with the electrolyte and with the lithiated carbon negative electrode, and subsequently to thermal runaway if the temperature of the cell reaches a critical value.

Sulfur was discovered as an overcharge protection agent for charged lithium-transition-metal oxide electrodes. The electrodes comprising sulfur showed a beneficial voltage drop phenomena and less heat generation relative to electrodes without sulfur at overcharging states, e.g., up to 5V.

As used herein, a lithium-ion secondary battery is understood to encompass a non-aqueous electrolyte secondary battery. A lithium-ion secondary battery generally comprises a cathode, an anode, an electrolyte, and a separator disposed between the cathode and anode. Secondary batteries are also known as rechargeable batteries because lithium batteries produce electrical energy by intercalation/deintercalation of lithium ions during oxidation and reduction occurring at the anode and the cathode, respectively.

As used herein, “electrodes” may encompass both negative and positive electrodes. A “negative electrode” is used interchangeably with the term anode, and a “positive electrode” is used interchangeably with the term cathode.

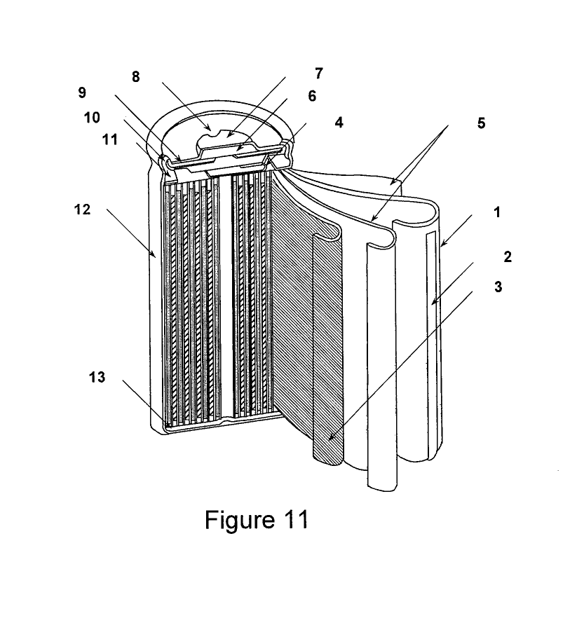

Referring to FIG. 11, the non-aqueous secondary battery may comprise negative electrode 1, negative lead tab 2, positive electrode 3, positive lead tab 4, separator 5, safety vent 6, top 7, exhaust hole 8, PTC (positive temperature coefficient) device 9, gasket 10, insulator 11, battery case or can 12, and insulator 13. Although the non-aqueous secondary battery is illustrated as cylindrical structure, any other shape, such as prismatic, aluminum pouch, or coin type may be used.

With respect to the positive electrode, it typically comprises a positive electrode current collector and, on the positive electrode current collector, a mixture comprising a positive electrode active material, a conductive material, and a binder.

The positive electrode current collector may be any conductive material that does not chemically or electrochemically change within the range of charge and discharge electric potentials used. The current collector may be a metal such as aluminum or titanium; an alloy comprising at least one of these metals such as stainless steel; or stainless steel surface-coated with carbon or titanium. The current collector may be, for example, a film, a sheet, a mesh sheet, a punched sheet, a lath form, a porous form, a foamed form, a fibrous form, or, preferably, a foil. In an exemplary embodiment, the current collector is aluminum foil. The current collector may be about 1-500 μm thick.

The positive electrode active material may include any compound containing lithium that is capable of occluding and of releasing lithium ions (Li⁺). A transition metal oxide, with an average discharge potential in the range of 3.0 to 4.25 V with respect to lithium, may be used. The lithium transition metal complex oxide may be selected from the group consisting of LiMPO₄, LiMO₂, LiM₂O₄, and mixtures thereof (where M is at least one transition metal or substitutes Al and/or Mg to the transition metal site). M may include Ti, V, Cr, Mn, Fe, Co, Ni, Al, Mg, and mixtures thereof. For example, a lithium transition metal complex oxide may include lithium cobalt oxide (LiCoO₂), lithium nickel oxide (LiNiO₂), lithium manganese oxide (LiMn₂O₄), lithium iron phosphate (LiFePO₄), lithium nickel manganese cobalt oxide LiNiₓMn_{y}CO_{z}O₂ (x+y+z=1), and lithium nickel cobalt aluminum oxide LiNiₓCO_{y}Al_{z}O₂ (x+y+z=1), etc. These lithium salts have high stability for high potential. In an exemplary embodiment, the lithium transition metal complex oxide is LiCoO₂.

At least a part of the surface of the positive electrode active material may be covered with a conductive material. Any conductive material known in the art can be used. Typical conductive materials include carbon, such as graphite, for example, natural graphite (scale-like graphite), synthetic graphite, and expanding graphite; carbon black, such as acetylene black, KETZEN® black (highly structured furnace black), channel black, furnace black, lamp black, and thermal black; conductive fibers such as carbon fibers and metallic fibers; metal powders such as titanium and stainless steel; organic conductive materials such as polyphenylene derivatives; and mixtures thereof. In an exemplary embodiment, the conductive material is acetylene black.

The binder for the positive electrode may be either a thermoplastic resin or a thermosetting resin. Useful binders include: polyvinyldifluoride (PVdF), polyethylene, polypropylene, polytetrafluoroethylene (PTFE), polyvinylidene fluoride, styrene/butadiene rubber, tetrafluoroethylene/hexafluoropropylene copolymers (FEP), tetrafluoroethylene/perfluoro-alkyl-vinyl ether copolymers (PFA), vinylidene fluoride/hexafluoropropylene copolymers, vinylidene fluoride/chlorotrifluoroethylene copolymers, ethylene/tetrafluoroethylene copolymers (ETFE), polychlorotrifluoro-ethylene (PCTFE), vinylidene fluoride/pentafluoropropylene copolymers, propylene/-tetrafluoroethylene copolymers, ethylene/chlorotrifluoroethylene copolymers (ECTFE), vinylidene fluoride/hexafluoropropylene/tetrafluoroethylene copolymers, vinylidene fluoride/perfluoromethyl vinyl ether/tetrafluoroethylene copolymers, and mixtures thereof. In an exemplary embodiment, the binder is polyvinyldifluoride.

The sulfur may be added to the positive electrode through a number of different techniques. The sulfur may be mixed with the active cathode material, e.g., the lithium transition metal complex oxide. This may include mixing the sulfur with the active cathode material, the binder, and the conductor. The sulfur may be deposited on the surface of the active cathode material, on the surface of the binder, on the surface of the conductor, or on the surface of the current collector. The sulfur may be deposited on the surface of the positive electrode as a coating by coating on the active cathode material and/or on the current collector directly. A “coating” may also include a film coating, coating to a certain thickness or a coating weight, or any other term generally understood in the art. In an exemplary embodiment, the sulfur is mixed with the active cathode material.

According to an embodiment of the present invention, a positive electrode comprises sulfur and an active cathode material. In several exemplary embodiments, the sulfur may be mixed with the active cathode material in a concentration or weight percentage basis of about 0.2 to about 5.0 weight % (e.g., 0.2 weight %, 0.5 weight %, 1.0 weight %, 2.0 weight %, or 5.0 weight %). In an exemplary embodiment, the sulfur is present in a concentration of less than about 5%. In another embodiment, the sulfur is present in a concentration of about 5%.

The positive electrode comprising sulfur generates less heat relative to a positive electrode without sulfur throughout a state of overcharge. As used herein, “a state of overcharge” is understood to mean when a battery is overcharged or is charged above its optimal operating cycle. A charging cycle may be charging at a rate of 0.2 C to 4.25V, and a discharge cycle may be discharging at a rate of 0.2 C to 3.0V. Embodiments of the invention were operated for up to three cycles of charging and discharging before overcharging the battery. Overcharge may be understood to occur at greater than 4.25V, e.g., overcharge may be quantified as charging to 5.0V.

As used herein, “heat generation” is understood to mean the heat produced or generated in the battery, e.g., via the electrode(s) and/or the electrolyte, during operation of the battery. Operation of the battery includes operating the battery by applying voltages, currents, etc. Operation may include operation in excess of the optimal or preferred ranges, e.g., operating the battery at a state of overcharge. Heat generation may be quantified as heat flow in Watts/gram or heat generation in Joules/gram. The heat generation throughout the state of overcharge of the positive electrode comprising sulfur may be up to 80% less relative to a positive electrode without sulfur. As used herein, “relative to” is understood to mean a comparison of one to another. Thus, the positive electrodes comprising sulfur are being compared to a positive electrode without or lacking sulfur. Heat generation of the electrodes is a valuable metric in determining whether the temperatures of the cell may reach or is likely to reach the critical value leading to thermal runaway. Such a thermal runaway is likely to lead to swelling, rupture, or combustion of the battery.

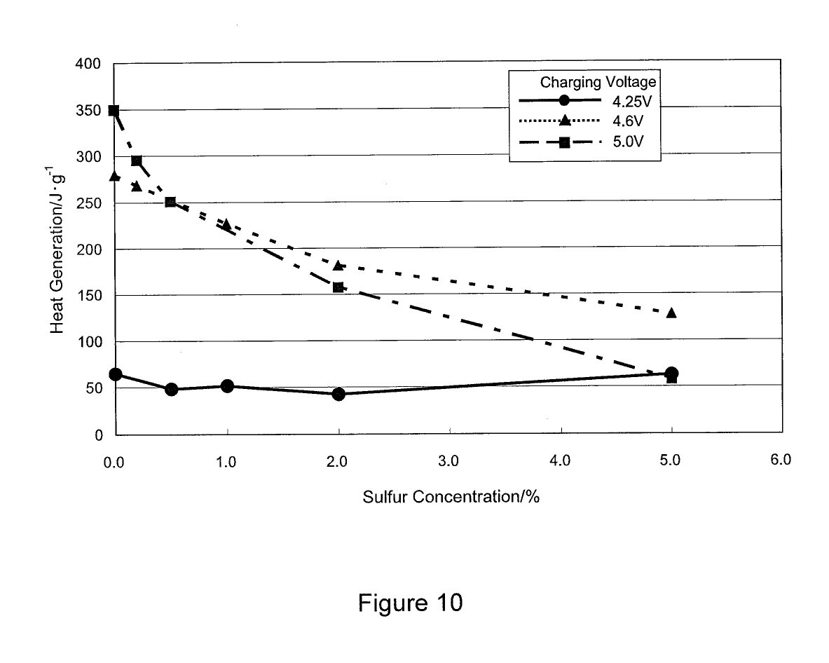

In a particular embodiment, the positive electrode comprising sulfur generates less heat relative to a positive electrode without sulfur throughout a state of overcharge. Referring to FIG. 10, the heat generation of a comparative example without sulfur and embodiments of the present invention comprising different amounts of sulfur are summarized. Specifically, FIG. 10 shows the non-sulfur LiCoO₂ electrode, e.g., 0.0 weight % of sulfur, and the LiCoO₂ electrodes comprising sulfur at different concentrations. The heat generation is shown for both a normal charging voltage of 4.25V and overcharging at 4.6V and 5.0V, respectively. For example, a non-sulfur LiCoO₂ electrode generated about 350 Joules/gram of heat, and a LiCoO₂ electrode with 5 weight % of sulfur generated about 60 Joules/gram of heat. Thus, 5 weight % of sulfur evidenced about a 80% reduction in the amount of heat generated for a non-sulfur LiCoO₂ electrode. In fact, all sulfur embodiments showed sulfur had the effect of reducing heat generation during over-charging the LiCoO₂ electrodes comprising sulfur. The sulfur did not appear to have any effect of reducing heat generation on normal charging of LiCoO₂ electrodes comprising sulfur at 4.25V.

Because the heat generation throughout the state of overcharge of the positive electrode comprising sulfur is minimized, it is unlikely the temperatures of the cell would reach the critical value which leads to thermal runaway and ultimately to the consequences of battery swelling, rupture, or combustion. Thus, the safety of the battery is greatly enhanced by adding sulfur as a simple overcharge protection agent.

The positive electrode may be prepared by mixing the positive electrode active material, the binder, and the conductive material with a solvent, such as N-methylpyrrolidone. The sulfur may be added to the positive electrode active material by mixing sulfur powder with the positive electrode active material ingredients. A current collector may then be coated with the active cathode material mixture. The resulting paste or slurry is coated onto the current collector by any conventional coating method, such bar coating, gravure coating, die coating, roller coating, or doctor knife coating. The coated current collector may then be dried and calendared to form the positive electrode. For example, the current collector may be dried to remove the solvent and then rolled under pressure after coating. The mixture of positive electrode active material, binder, and conductive material may comprise the positive electrode active material, including at least enough conductive material for good conductivity, and at least enough binder to hold the mixture together.

The sulfur may be in the form of elemental sulfur and/or one or more sulfur organic compounds (i.e., organic compounds containing one or more sulfur atoms). Suitable sulfur organic compounds include, for example, sulfides, in particular aromatic and polyaromatic compounds containing two or more sulfur atoms per molecule. With respect to the negative electrode, it also comprises a negative electrode current collector and, on the current collector, a mixture comprising a negative electrode active material, a conductive material, and a binder.

The negative electrode current collector may be any conductive material that does not chemically or electrochemically change within the range of charge and discharge electric potentials used. The current collector may be a metal such as aluminum, copper, nickel, iron, titanium, or cobalt; an alloy comprising at least one of these metals such as stainless steel; or copper or stainless steel surface-coated with carbon, nickel or titanium. The current collector may be, for example, a film, a sheet, a mesh sheet, a punched sheet, a lath form, a porous form, a foamed form, a fibrous form, or, preferably, a foil. The current collector may be about 1-500 μm thick.

The negative electrode active material may comprise a graphite and/or lithium alloy and/or lithium titanate (Li₄Ti₅O₁₂). The lithium alloy comprises at least one transition metal or a P-element selected from the group consisting of Si, Sn, Al, Pb, Bi, In, Ag, Pt, and Ti.

At least a part of the surface of the negative electrode active material may be covered with a conductive material. Any conductive material known in the art can be used. Typical conductive materials include carbon, such as graphite, for example, natural graphite (scale-like graphite), synthetic graphite, and expanding graphite; carbon black, such as acetylene black, KETZEN® black (highly structured furnace black), channel black, furnace black, lamp black, and thermal black; conductive fibers such as carbon fibers and metallic fibers; metal powders such as copper, aluminum, cobalt, titanium, stainless steel, and nickel; organic conductive materials such as polyphenylene derivatives; and mixtures thereof.

The binder for the negative electrode may be either a thermoplastic resin or a thermosetting resin. Useful binders include: polyethylene, polypropylene, polytetrafluoroethylene (PTFE), polyvinylidene fluoride (PVDF, also known as polyvinyldifluoride), styrene/butadiene rubber, tetrafluoroethylene/hexafluoropropylene copolymers (FEP), tetrafluoro-ethylene/perfluoro-alkyl-vinyl ether copolymers (PFA), vinylidene fluoride/-hexafluoropropylene copolymers, vinylidene fluoride/chlorotrifluoroethylene copolymers, ethylene/tetrafluoroethylene copolymers (ETFE), polychlorotrifluoro-ethylene (PCTFE), vinylidene fluoride/pentafluoropropylene copolymers, propylene/-tetrafluoroethylene copolymers, ethylene/chlorotrifluoroethylene copolymers (ECTFE), vinylidene fluoride/hexafluoropropylene/tetrafluoroethylene copolymers, vinylidene fluoride/perfluoromethyl vinyl ether/tetrafluoroethylene copolymers, and mixtures thereof.

The negative electrode may be prepared by mixing the negative electrode active material, the binder, and the conductive material with a solvent, such as N-methylpyrrolidone. The resulting paste or slurry is coated onto the current collector by any conventional coating method, such bar coating, gravure coating, die coating, roller coating, or doctor knife coating. The current collector may be dried to remove the solvent and then rolled under pressure after coating. The mixture of negative electrode active material, binder, and conductive material may comprise the negative electrode active material, including at least enough conductive material for good conductivity, and at least enough binder to hold the mixture together.

With respect to the electrolyte, it comprises a non-aqueous solvent, or mixture of non-aqueous solvents, with a lithium salt or a mixture of lithium salts dissolved therein.

A non-aqueous electrolyte normally selected is one capable of withstanding oxidation at a positive electrode that discharges at a high potential of 3.0 to 4.25 V and also is capable of enduring a reduction at a negative electrode that charges and discharges at a potential close to that of lithium. Typically, a non-aqueous electrolyte is obtained by dissolving lithium hexafluorophosphate (LiPF₆) in a mixed solvent of ethylene carbonate (EC), having a high dielectric constant, and a linear carbonate as a low viscosity solvent. Linear carbonates, include, for example, diethyl carbonate (DEC), dimethyl carbonate (DMC), ethyl methyl carbonate (EMC), and similar carbonates.

Thus, non-aqueous solvents may include, for example, cyclic carbonates such as ethylene carbonate (EC), propylene carbonate (PC), butylene carbonate (BC); open chain carbonates such as dimethyl carbonate (DMC), diethyl carbonate (DEC), and ethylmethyl carbonate (EMC); and mixtures thereof. These electrolytes were selected because they have high stability for high potential. The above electrolytes, particularly EC, DMC, DEC, and EMC, are preferred in combination with the sulfur embodiments of the present invention because they were discovered to provide the optimum overcharge protection for the lithium ion batteries. In an exemplary embodiment, ethylene carbonate and ethyl methyl carbonate are present at a volume ratio of 1:3, respectively.

Lithium salts may include, for example, lithium hexafluorophosphate (LiPF₆), lithium hexafluoroarsenate (LiAsF₆), lithium tetrafluoroborate (LiBF₄), lithium perchlorate (LiClO₄), and mixtures thereof. A reaction may occur between the elemental sulfur and sulfur cation. A sulfur cation exists over 4.5V when using lithium salts with high stability and high potential such as LiPF₆, LiAsF₆, LiBF₄, and LiClO₄.

The non-aqueous electrolyte may be obtained by dissolving a lithium salt, e.g., lithium hexafluorophosphate (LiPF₆), in a mixed solvent, e.g., of ethylene carbonate (EC), which has a high dielectric constant, and a linear carbonate or mixture of linear carbonates that are low-viscosity solvents, such as ethyl methyl carbonate (EMC).

Other compounds, such as additives, may be added to the non-aqueous electrolyte in order to improve discharge and charge/discharge properties. Such compounds include triethyl phosphate, triethanolamine, cyclic ethers, ethylene diamine, pyridine, triamide hexaphosphate, nitrobenzene derivatives, crown ethers, quaternary ammonium salts, and ethylene glycol di-alkyl ethers.

With respect to the separator, it is generally insoluble and stable in the electrolyte solution. The separator's purpose is to prevent short circuits by insulating the positive electrode from the negative electrode. Insulating thin films with fine pores, which have a large ion permeability and a predetermined mechanical strength, may be used. Polyolefins, such as polypropylene and polyethylene, and fluorinated polymers such as polytetrafluoroethylene and polyhexafluoropropylene, may be used individually or in combination. Sheets, non-wovens and wovens made with glass fiber may also be used. The diameter of the fine pores of the separators is typically small enough so that positive electrode materials, negative electrode materials, binders, and conductive materials that separate from the electrodes can not pass through the separator. A desirable diameter may be, for example, 0.01-1 μm. The thickness of the separator may be in the range of 10-300 μm. The porosity is determined by the permeability of electrons and ions, material and membrane pressure and may be in the range of 30-80%.

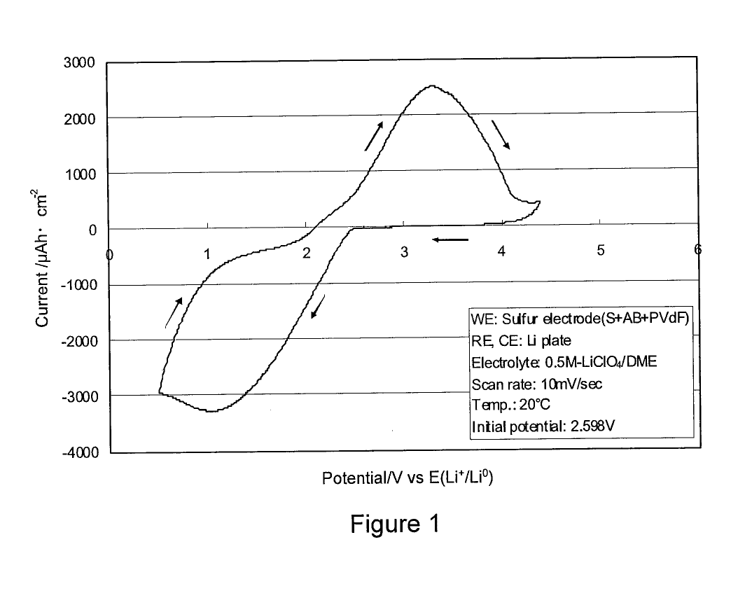

Referring now to FIG. 1, as a comparative example, sulfur reacts with lithium under 2.5V and de-lithiates over 2.1V up to 4V in ether base electrolyte (0.5M-LiClO₄/DME electrolyte). Most ether electrolytes decompose up to 4.2V, thus causing a potential battery hazard.

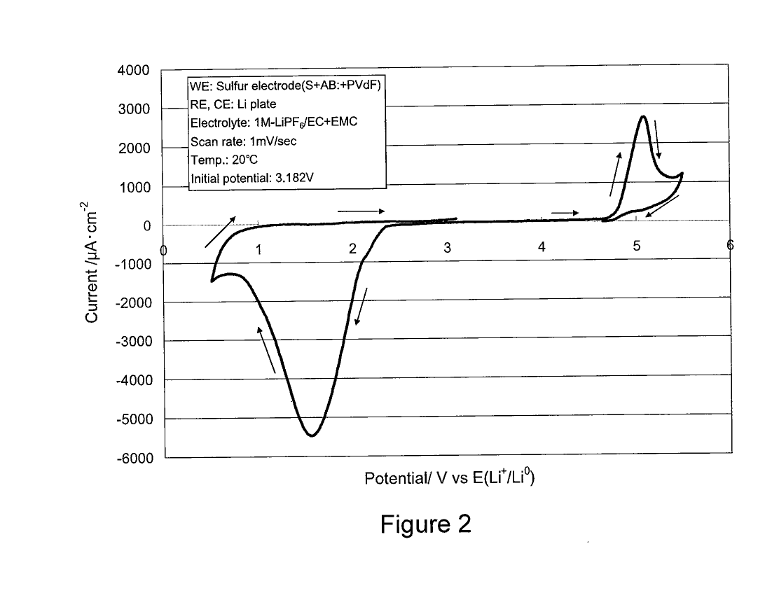

Referring now to FIG. 2, sulfur does not react with the anion of a suspended lithium salt until 4.7V, when ester (e.g., carbonate) electrolytes such as EC, EMC, DMC and DEC are used. Similar to using the ether base electrolyte, however, a cathodic reaction (reaction with lithium) occurs under 2.5V. Thus, an advantage of using an ester base electrolyte is higher anodic reaction potential of sulfur than comparable ether base electrolytes. Lithium ion batteries may also use ester base electrolytes because the operating voltage is higher than the decomposition potential of the ether.

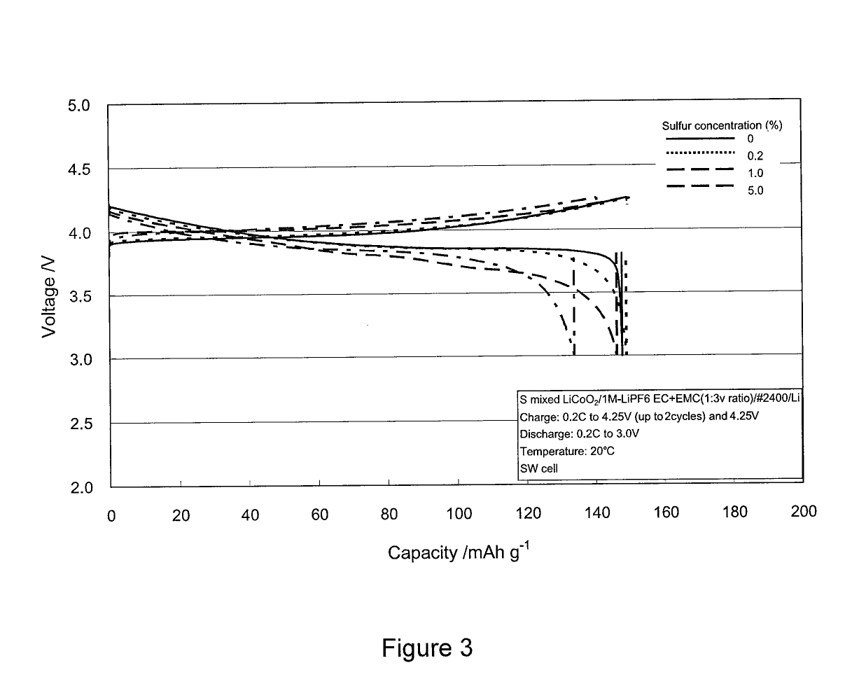

Referring now to FIG. 3, the charging and discharging curves of sulfur mixed LiCoO₂ electrodes are shown. The capacity decreases about 10% by adding 5% of sulfur, and by adding sulfur, the discharging voltage is slightly polarized as compared to a LiCoO₂ electrode lacking sulfur because sulfur is electrochemically inactive in this potential range and may occupy the electrode partially by weight and volume. Even with the addition of sulfur, however, the electrodes are still at a useful operating voltage and capacity.

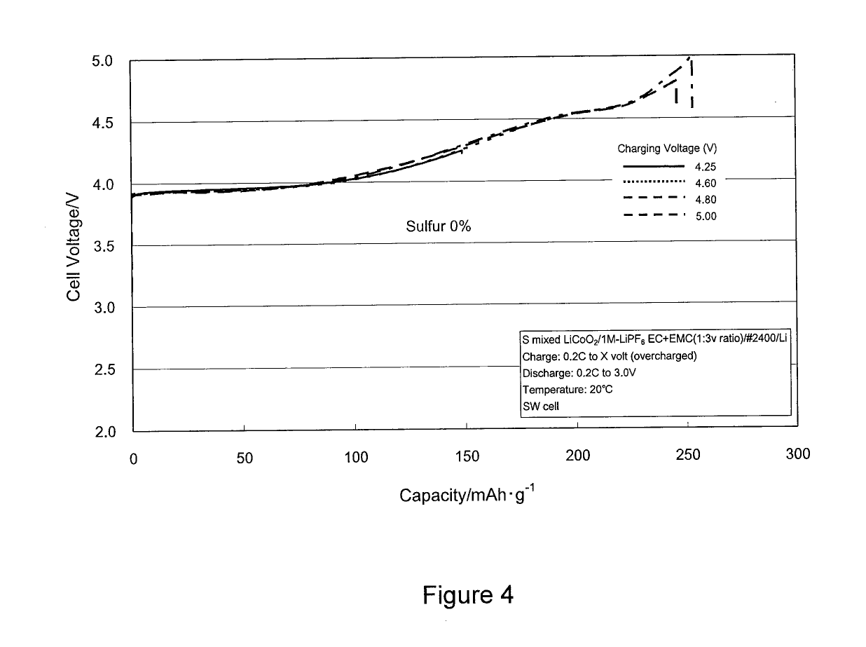

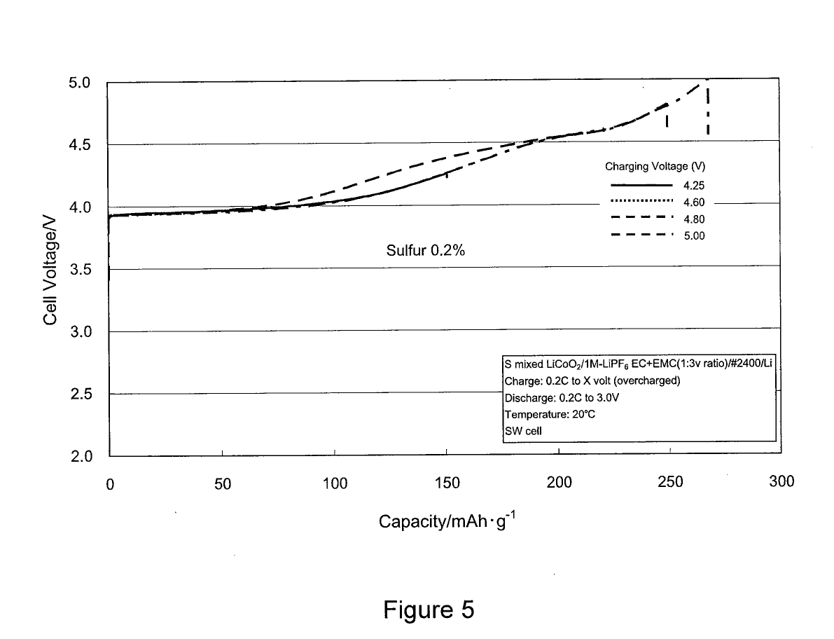

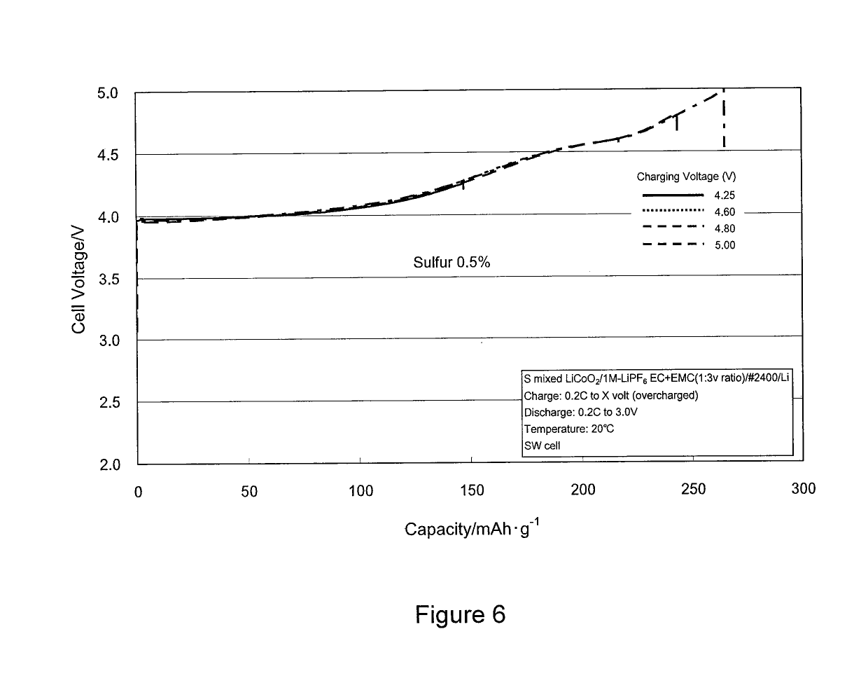

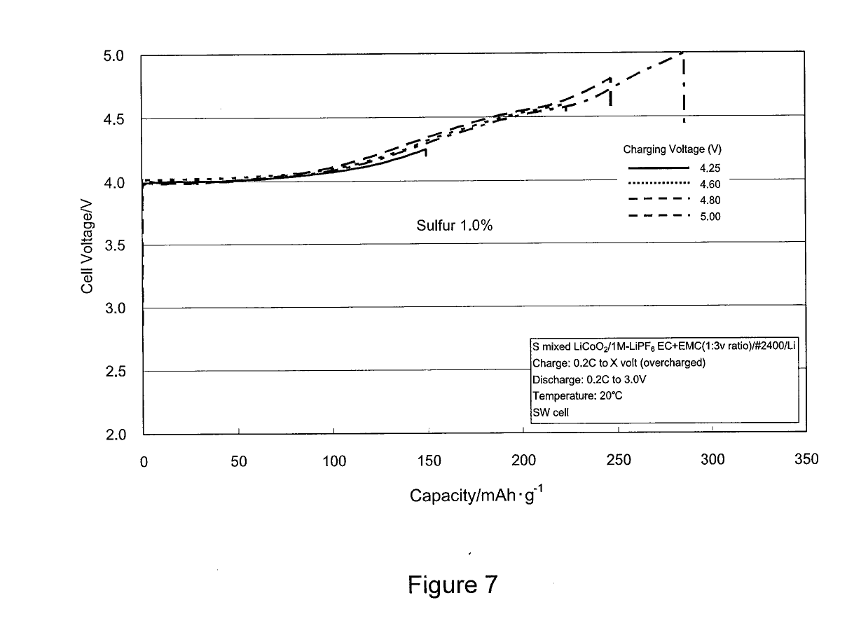

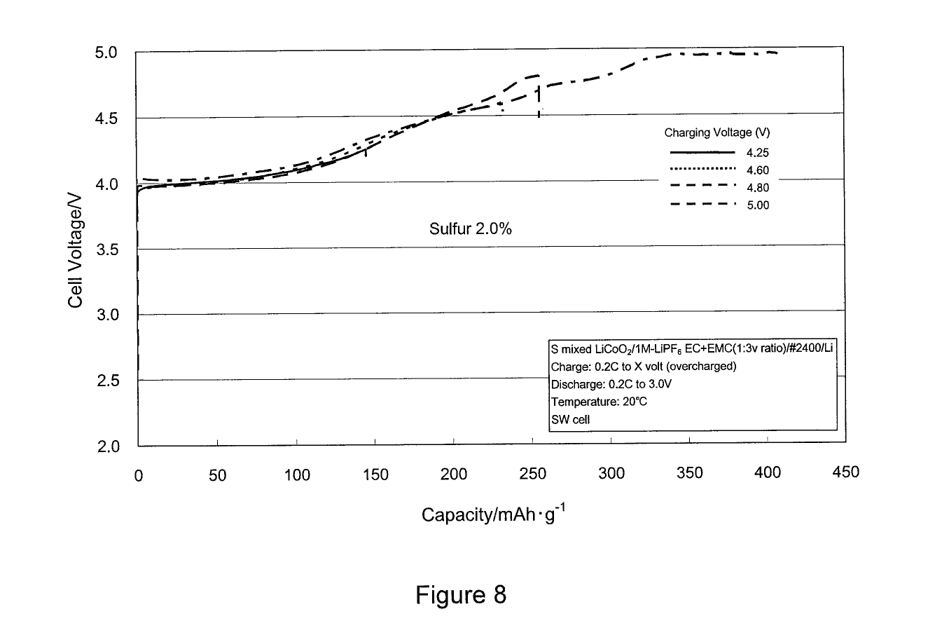

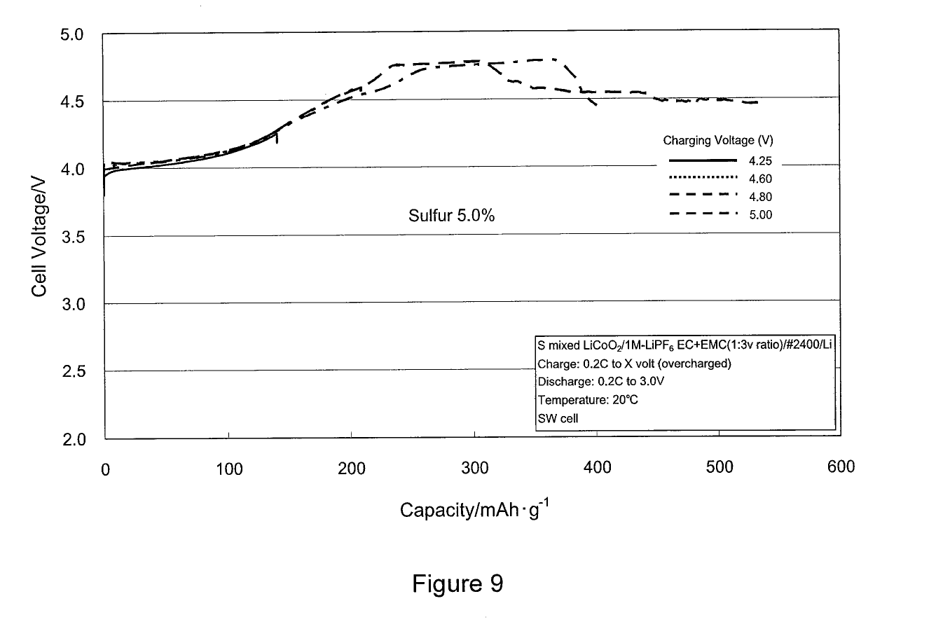

Referring now to FIGS. 4 through 9, after 4.25V-3.0V charging and discharging, the battery cells were overcharged. The overcharging behaviors of LiCoO₂ with several concentration of sulfur are shown. The overcharging behaviors for a high concentration of sulfur, in the range of 2 to 5 weight percent, are different from LiCoO₂ electrodes with low concentration of sulfur and LiCoO₂ electrodes. The LiCoO₂ electrode with the high concentration of sulfur showed voltage fade over 4.7V. Without wishing to be bound to a particular theory, this voltage fade was believed to cause the cell to short circuit when the cell voltage reached to about 4.7V of sulfur reaction as shown in FIG. 2. This may occur because the sulfur may react with the anion, the sulfur may give electrons to the cobalt, resulting in reduced cobalt, for example possibly Co(II), and may dissolve into the electrolyte and migrate to and deposit on the anode. Because the electrodes comprising sulfur may cause a short circuit phenomena, the safety of the battery is improved and the likelihood of the battery combusting or rupturing is greatly decreased.

When a lithium secondary cell is overcharged, the sulfur reacts with the anion of the lithium salt and dissolves into the electrolyte over the potential of 4.5V for the cathode as opposed to the potential of the lithium metal. The dissolved sulfur cation can immigrate to the anode and reduce on the surface of the anode. The reduced sulfur can also immigrate to the cathode and oxidize. The reaction may continue throughout overcharging. The reaction does not generate gas or generates only a small amount because the oxidized sulfur cation dissolves into the electrolyte and combines with the anion of the lithium salt. Thus, without the reaction of the sulfur during overcharge, the electrolyte would have decomposed, generated gases, and potentially resulted in a thermal runaway.

As used herein, “stable” is understood to mean throughout a state of overcharge, the battery comprising sulfur generates less heat relative to a comparable battery not comprising sulfur such that the heat generated in the battery during operation, e.g., via the electrolyte and/or the electrode(s), does not result in an increase in temperature of the battery sufficient to trigger a thermal runaway and the consequences of such. Thus, when a battery is stable during overcharge, minimal and perhaps no measurable degradation or decomposition of the electrolyte and/or generation of gases occur.

According to embodiments of the present invention, sulfur-containing mixed LiCoO₂ electrodes and LiCoO₂ samples after overcharging were measured for their thermal behaviors by differential scanning calorimetry (DSC). Heat generation during 100-400° C. was calculated from the DSC curves. The summary of the heat generations of the comparative example and each of the embodiments are shown in FIG. 10. It was discovered that the heat generation decreases when the sulfur concentration increases. Even a small amount of sulfur, however, of less than 0.2% causes an effect of reducing heat generation during overcharging of a LiCoO₂ electrode.

Sulfur reduces the heat generation typically encountered from overcharging a LiCoO₂ electrode. The concentration of sulfur appears to be an important factor to reduce the heat generation and to make a short circuit for safety at overcharging.

This technique is particularly useful for 4V cathodes such as LiMn₂O₄, LiCoO₂ and LiNiO₂ and their transition metal substituted materials. Thus, sulfur was discovered as an effective overcharge protection agent for 4V batteries.

According to an embodiment of the present invention, a method of using a lithium secondary battery comprises overcharging a lithium secondary battery comprising a negative electrode, a positive electrode comprising sulfur and an active cathode material comprising a lithium transition metal complex oxide, and an electrolyte comprising at least one lithium salt and at least one solvent. The heat generation of the positive electrode comprising sulfur is maintained at levels lower relative to a positive electrode without sulfur during the overcharge.

As previously discussed, the addition of sulfur reduces the heat generated during an overcharge. Thus, there is less heat generation than typically seen in a LiCoO₂ electrode without sulfur at overcharging states of up to 5.0V. The overcharge may be charging to greater than 4.25V. The heat generation during the overcharge of the positive electrode comprising sulfur may be up to 80% less relative to a positive electrode without sulfur. Furthermore, the sulfur embodiments showed a beneficial short circuit phenomena during the overcharge. Thus, sulfur is an effective overcharge protection agent for lithium ion secondary batteries.

### EXAMPLES

The following examples are included to more clearly demonstrate the overall nature of the present invention. In particular, the examples describe exemplary methods for making an electrode comprising sulfur where the sulfur acts a simple overcharge protection agent by reducing heat generation throughout overcharge and/or causing a short circuit phenomena.

LiCoO₂ electrodes with sulfur were fabricated according to the following procedure. LiCoO₂ powder (FMC Corporation), sulfur powder (Sigma-Aldrich) and AB (Acetylene black, Denka Kogyo K.K.) were weighed and mixed well on mortar with pestle after mixing with a vortex mixer (Labnet International, S0100) for 1 minute. NMP (N-Methylpyrrolidone, Sigma-Aldrich anhydrous NMP) was added to the mixture of LiCoO₂, sulfur powder, and AB and was then mixed well using the vortex mixer for 1 minute. Next, 10%-PVdF (polyvinyldifluoride, Solvay)/NMP solution was added to the mixture and mixed well using the vortex mixer for 1 minute. The final compositions of the mixtures are listed below in Table 1.

TABLE 1
Compositions of Sulfur added LiCoO₂ electrodes
(unit: weight %)

| Lot | LiCoO₂ | Sulfur | AB | PVdF |
|---|---|---|---|---|
| 1 | 84.6 | 0.0 | 5.0 | 10.4 |
| 2 | 84.5 | 0.2 | 5.0 | 10.3 |
| 3 | 84.1 | 0.5 | 4.9 | 10.5 |
| 4 | 83.6 | 1.0 | 5.0 | 10.4 |
| 5 | 82.8 | 2.0 | 5.0 | 10.2 |
| 6 | 79.6 | 5.0 | 5.0 | 10.4 |

The mixture pastes were coated on aluminum foil with 20 μm thickness using a Doctor Blade with a gap of 200 μm and then dried at 60° C. for 1 hour under air atmosphere. After it dried, LiCoO₂ and sulfur-containing mixed LiCoO₂ electrodes were calendared using a roll press.

Electrochemical evaluation was carried out with a Swagelok cell. A lithium electrode of 9.2 mm diameter with 0.140 mm thickness was used as the negative electrode. A porous polypropylene separator (9.8 mm diameter, Celgard #2400, 2 ply) was used. 1M-LiPF₆ in EC (ethylene carbonate, Ferro lithium battery grade) and EMC (ethyl-methyl carbonate, Ferro lithium battery grade) solution with volume ratio EC/EMC=1/3 was used as the electrolyte. LiCoO₂ and sulfur mixed LiCoO₂ electrodes (punched 8.6 mm diameter), separators, and a negative electrode were sandwiched between an aluminum pellet (9.4 mm diameter with 1 mm thickness) as a positive current collector and a nickel pellet (9.4 mm diameter with 1 mm thickness) as a negative current corrector. A spring was used for pressing both electrodes. The Swagelok cells were charged at a 0.2 C rate to 4.25V and discharged at a rate of 0.2 C to 3.0V at first. The Swagelok cells were then over-charged to up to 5.0V.

After over-charging of the Swagelok cells, they were disassembled and the LiCoO₂ and sulfur-containing mixed LiCoO₂ electrodes were rinsed by anhydrous DMC (dimethyl carbonate, Ferro lithium battery grade) in an argon dry box. A sample was then taken to an aluminum pan and sealed with an aluminum lid for measurement by DSC (TA Instruments, Differential Scanning calorimeter Q10). Samples of LiCoO₂ and sulfur-containing mixed LiCoO₂ electrodes excluding aluminum foil were measured for their thermal behaviors by DSC with 5° C./min to 400° C.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A lithium secondary battery comprising:
a negative electrode;
a positive electrode comprising a current collector, an active cathode material comprising a lithium transition metal complex oxide, and sulfur; and
an electrolyte comprising at least one lithium salt and at least one solvent, the at least one lithium salt being selected from the group consisting of LiPF₆, LiAsF₆, LiBF₄, LiClO₄, and mixtures thereof, and the at least one solvent being selected from the group consisting of ethylene carbonate, propylene carbonate, butylene carbonate, ethyl methyl carbonate, dimethyl carbonate, diethyl carbonate, and mixtures thereof;
wherein the electrolyte remains stable throughout a state of overcharge.

2. A lithium secondary battery according to claim 1, wherein the lithium transition metal complex oxide is selected from the group consisting of LiMPO₄, LiMO₂ and LiM₂O₄ (where M is one or more transition metals or substitutes Al and/or Mg to the transition metal site).

3. A lithium secondary battery according to claim 1, wherein the lithium transition metal complex oxide is LiCoO₂.

4. A lithium secondary battery according to claim 1, wherein the negative electrode comprises a graphite and/or lithium titanate (Li₄Ti₅O₁₂) and/or lithium alloy comprising a transition metal and/or a P-element selected from the group consisting of Si, Sn, Al, Pb, Bi, In, Ag, Pt, Ti, and mixtures thereof.

5. A lithium secondary battery according to claim 1, wherein the sulfur is selected from the group consisting of elemental sulfur and sulfur organic compounds.

6. A lithium secondary battery according to claim 1, wherein the at least one solvent is ethylene carbonate and ethyl methyl carbonate.

7. A lithium secondary battery according to claim 6, wherein the ethylene carbonate and ethyl methyl carbonate are present at a volume ratio of 1:3, respectively.

8. A lithium secondary battery according to claim 1, wherein the at least one lithium salt is LiPF₆.

9. A lithium secondary battery according to claim 1, wherein the sulfur is present in a concentration of less than 5%.

10. A lithium secondary battery according to claim 1, wherein the sulfur is present in a concentration in the range of 0.2 to 5.0 weight %.

11. A lithium secondary battery according to claim 1, wherein the positive electrode comprises sulfur by one of the sulfur is mixed with the lithium transition metal complex oxide, the sulfur is coated on the active cathode material, and the sulfur is coated on the current collector.

12. A lithium secondary battery according to claim 1, wherein the battery is a 4V battery.

13. A lithium secondary battery according to claim 1, wherein the state of overcharge is charging to greater than 4.25V.

14. A lithium secondary battery according to claim 1, wherein the state of overcharge is charging to about 5V.

15. A lithium secondary battery comprising:
a cathode comprising a mixture of sulfur and a lithium transition metal complex oxide selected from the group consisting of LiMPO₄, LiMO₂ and LiM₂O₄ (where M is one or more transition metals or substitutes Al and/or Mg to the transition metal site);
an anode comprising a graphite and/or lithium titanate (Li₄Ti₅O₁₂) and/or lithium alloy comprising a transition metal and/or a P-element selected from the group consisting of Si, Sn, Al, Pb, Bi, In, Ag, Pt, Ti, and mixtures thereof; and
an electrolyte comprising at least one lithium salt selected from the group consisting of LiPF₆, LiAsF₆, LiBF₄, and LiClO₄ and at least one solvent selected from the group consisting of ethylene carbonate, propylene carbonate, butylene carbonate, ethyl methyl carbonate, dimethyl carbonate, and diethyl carbonate;
wherein the electrolyte remains stable at a state of overcharge.

16. A method of using a lithium secondary battery comprising:
overcharging a lithium secondary battery comprising a negative electrode, a positive electrode comprising sulfur and an active cathode material comprising a lithium transition metal complex oxide, and an electrolyte comprising at least one lithium salt and at least one solvent,
wherein the heat generation of the positive electrode comprising sulfur is maintained at levels lower relative to a positive electrode without sulfur during the overcharge.

17. A method of using a lithium secondary battery according to claim 16, wherein the step of overcharging comprises charging to greater than 4.25V.

18. A method of using a lithium secondary battery according to claim 16, wherein the sulfur causes a short circuit at the overcharge.

19. A lithium secondary battery according to claim 2, wherein M is selected from the group consisting of Ti, V, Cr, Mn, Fe, Co, Ni, Al, Mg, and mixtures thereof.

20. A lithium secondary battery according to claim 15, wherein M is selected from the group consisting of Ti, V, Cr, Mn, Fe, Co, Ni, Al, Mg, and mixtures thereof.
